(19) United States
(12) Patent Application Publication
(10) Pub. No.: US 2017/0155568 A1
(43) Pub. Date: Jun. 1, 2017

(54) FAILURE DETERMINATION METHOD AND TRANSMISSION DEVICE

(71) Applicant: FUJITSU LIMITED, Kawasaki-shi (JP)

(72) Inventor: Masakatsu Koyanagi, Fukuoka (JP)

(73) Assignee: FUJITSU LIMITED, Kawasaki-shi (JP)

(21) Appl. No.: 15/351,682

(22) Filed: Nov. 15, 2016

(30) Foreign Application Priority Data
Nov. 27, 2015 (JP) 2015-232432

(51) Int. Cl. H04L 12/26

(52) U.S. Cl. CPC H04L 43/10; H04L 43/50

(57) ABSTRACT

A failure determination method executed by a transmission device, the failure determination method includes acquiring first identification information to identity types of a plurality of signals that have passed through an input terminal of the transmission device; generating a monitoring signal in which the first identification information is stored and inserting the generated monitoring signal into the input terminal; acquiring second identification information to identify the types of the plurality of signals when the plurality of signals transmitted through the input terminal pass through an output terminal of the transmission device; extracting the first identification information from the monitoring signal that is transmitted from the input terminal and is detected at the output terminal; and determining path failure between the input terminal and the output terminal regarding each of a plurality of types by comparing the second identification information and the first identification information extracted from the monitoring signal.

### CROSS-REFERENCE TO RELATED APPLICATION

This application is based upon and claims the benefit of priority of the prior Japanese Patent Application No. 2015-232432, filed on Nov. 27, 2015, the entire contents of which are incorporated herein by reference.

### FIELD

The embodiments discussed herein are related to a failure determination method and a transmission device.

### BACKGROUND

Failure monitoring between transmission devices can be implemented by continuity check message (CCM) monitoring processing of OAM (operations, administration and maintenance) (IEEE (Institute of Electrical and Electronic Engineers) 802.1ag, ITU-T Y.1731). For example, the transmission device receives a CCM frame periodically transmitted from the counterpart device and can check the continuity of the logical line path between the transmission device and the counterpart device on the basis of whether or not this CCM frame arrives or comparison of a parameter in the frame.

Regarding failure monitoring in the transmission device, the continuity of the logical line path in the self-device can be checked by generating and monitoring a monitoring frame in the self-device. The transmission device periodically inserts the monitoring frame into the input terminal of the communication path of the self-device and monitors whether or not the monitoring frame arrives at the output terminal of the communication path. If the monitoring frame does not arrive, the transmission device can determine that the line path in the device is in failure. As related arts, Japanese Laid-open Patent Publication No. 2007-215066, International Publication Pamphlet No. WO2008/114364, and so forth are disclosed for example.

In the transmission device, a queue is provided for each of user types or class types of the frame for example. Furthermore, the path through which the frame passes differs for each queue. However, in the transmission device, the monitoring frame is not inserted on each queue basis. As a result, even when actually failure has occurred on the path of a partial queue in plural queues, if the monitoring frame is caused to pass through the path of another queue, the transmission device does not detect path failure because it is determined that the continuity of the line path in the device is normal. In view of the above, it is preferable that path failure can be determined with higher accuracy.

### SUMMARY

According to an aspect of the embodiment, a failure determination method executed by a transmission device, the failure determination method includes acquiring first identification information to identity types of a plurality of signals that have passed through an input terminal of the transmission device; generating a monitoring signal in which the first identification information is stored and inserting the generated monitoring signal into the input terminal; acquiring second identification information to identify the types of the plurality of signals when the plurality of signals transmitted through the input terminal pass through an output terminal of the transmission device; extracting the first identification information from the monitoring signal that is transmitted from the input terminal and is detected at the output terminal; and determining path failure between the input terminal and the output terminal regarding each of a plurality of types by comparing the second identification information and the first identification information extracted from the monitoring signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating one example of a configuration in a transmission device of embodiment 1;

FIG. 2 is an explanatory diagram illustrating one example of a flow of frames in a transmission device;

FIG. 3 is an explanatory diagram illustrating one example of a flow of frames and a monitoring frame at each of points in a transmission device;

FIG. 4 is a flowchart illustrating one example of processing operation of a second control unit regarding first failure determination processing;

FIG. 5 is an explanatory diagram illustrating one example of a configuration in a transmission device of embodiment 2;

FIG. 6 is an explanatory diagram illustrating one example of a flow of frames and a monitoring frame at each of points in a transmission device;

FIG. 7 is an explanatory diagram illustrating one example of a flow of frames and a monitoring frame in a transmission device;

FIG. 8 is an explanatory diagram illustrating one example of a flow of frames and monitoring frames at each of points in a transmission device when paths are normal;

FIG. 9 is an explanatory diagram illustrating one example of frame information, stored information, and difference information (when paths are normal);

FIG. 10 is an explanatory diagram illustrating one example of a flow of frames and monitoring frames at each of points in a transmission device (when a path is in failure);

FIG. 11 is an explanatory direction illustrating one example of frame information, stored information, and difference information (when a path is in failure); and

FIG. 12 is a flowchart illustrating one example of processing operation of a fourth control unit regarding second failure determination processing.

### DESCRIPTION OF EMBODIMENTS

Embodiments of a transmission device and a failure determination method disclosed by the present application will be described in detail below on the basis of the drawings. Disclosed techniques are not limited by the present embodiments. The embodiments represented below may be combined as appropriate within a range in which inconsistency is not caused.

### Embodiment 1

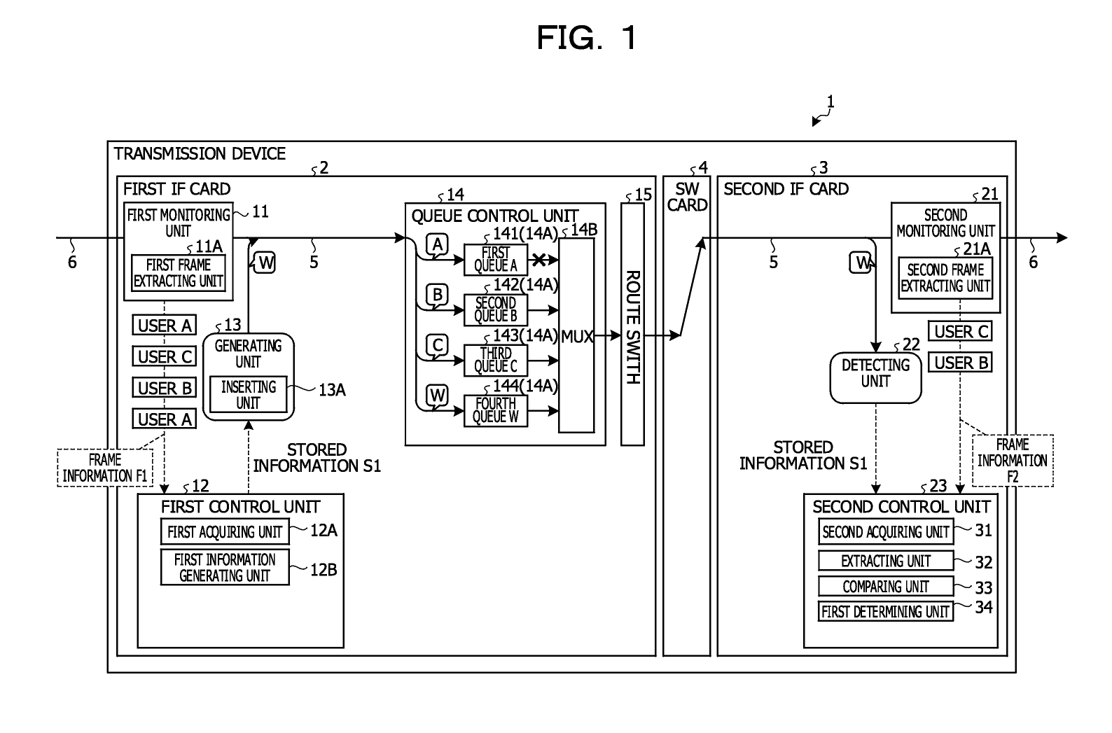

FIG. 1 is an explanatory diagram illustrating one example of a configuration in a transmission device of embodiment 1. A transmission device 1 illustrated in FIG. 1 includes a first IF card 2, a second IF card 3, an SW card 4, and a communication path 5. The first IF card 2 and the second IF card 3 are communication interfaces responsible for communications with a transmission line 6 to which this transmission device 1 is coupled. The SW card 4 is a switch that switches and couples the communication path 5 between the first IF card 2 and the second IF card 3.

The transmission device 1 transmits frames from the first IF card 2 to the second IF card 3 via the SW card 4. The first IF card 2 includes a first monitoring unit 11, a first control unit 12, a generating unit 13, a queue control unit 14, and a route switch 15.

The first monitoring unit 11 monitors frames that pass through a point P1 on the communication path 5 in the first IF card 2. The point P1 is a point on the communication path 5 in the first monitoring unit 11. The first monitoring unit 11 includes a first frame extracting unit 11A that monitors frames that pass through the point P1 of the communication path 5 and extracts frame information F1 including identification information to identify the user types of the frames.

The first control unit 12 includes a first acquiring unit 12A and a first information generating unit 12B. The first acquiring unit 12A acquires the frame information F1 from the first monitoring unit 11. The first information generating unit 12B generates stored information S1 on the basis of the acquired frame information F1. The stored information S1 is information in which identification information to identify the user type of each frame that has passed through the point P1 by immediately before output of a monitoring frame W is stored on the basis of the acquired frame information F1. For example, the stored information S1 is the user type of each frame that has passed through the point P1 in the period from insertion of the previous monitoring signal W to insertion of the present monitoring signal W. The first control unit 12 outputs the generated stored information S1 to the generating unit 13.

The generating unit 13 generates the monitoring frame W and outputs the monitoring frame W to a point P2 of the communication path 5. The point P2 is a point on the communication path 5 between the first monitoring unit 11 and the queue control unit 14. For example, the monitoring frame W is a frame periodically output in order to check the path continuity of the frames that pass through the communication path 5 in the transmission device 1. The generating unit 13 includes an inserting unit 13A that stores the stored information S1 in the monitoring frame W.

The queue control unit 14 includes plural queues 14A and a multiplexer (MUX) 14B. The queue 14A is a region that is disposed for each user type and temporarily stores the frame corresponding to the relevant user type. The queues 14A include a first queue 141, a second queue 142, a third queue 143, and a fourth queue 144 for example. The first queue 141 is a region that temporarily stores the frame of a user A for example. The second queue 142 is a region that temporarily stores the frame of a user B for example. The third queue 143 is a region that stores the frame of a user C for example. The fourth queue 144 is a region that stores the monitoring frame W. The multiplexer 14B outputs the frames stored in the respective queues 14A. The route switch 15 is a switch that switches and outputs the route according to the user type of the frame.

The second IF card 3 includes a second monitoring unit 21, a detecting unit 22, and a second control unit 23. The second monitoring unit 21 monitors frames that pass through a point P3 on the communication path 5 in the second IF card 3. The point P3 is a point on the communication path 5 in the second monitoring unit 21. The second monitoring unit 21 includes a second frame extracting unit 21A that monitors frames that pass through a point P4 of the communication path 5 and extracts frame information F2 including the identification information to identify the user types of the frames. The point P4 is a point on the communication path 5 between the input stage in the second IF card 3 and the second monitoring unit 21.

The detecting unit 22 monitors the monitoring frame W that passes through the point P3 of the communication path 5 in the second IF card 3. The second control unit 23 includes a second acquiring unit 31, an extracting unit 32, a comparing unit 33, and a first determining unit 34. The second acquiring unit 31 acquires the frame information F2 of the point P4 extracted by the second monitoring unit 21. The frame information F2 is the user types of the frames that have passed through the point P4 in the period from detection of the previous monitoring signal W by the detecting unit 22 to detection of the present monitoring signal W. The extracting unit 32 extracts the stored information S1 stored in the monitoring frame W detected by the detecting unit 22. The comparing unit 33 compares the frame information F2 acquired by the second acquiring unit 31 and the stored information S1 extracted in the extracting unit 32. The first determining unit 34 determines whether or not path failure exists regarding each user frame on the basis of the difference between the frame information F2 and the stored information S1. If the frame information F2 is the frames of the users B and C and the stored information S1 is the frames of the users A to C, the first determining unit 34 determines that the frame of the user A has not arrived and determines that the path of the user A is in failure on the basis of the difference between the frame information F2 and the stored information S1.

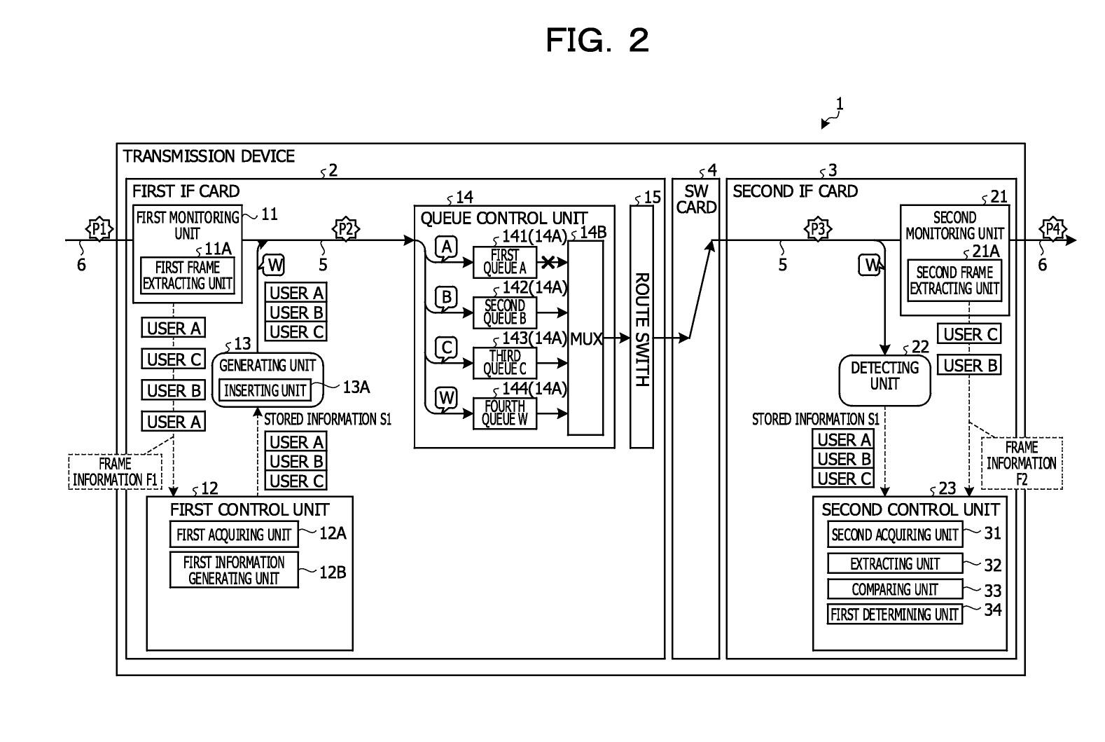

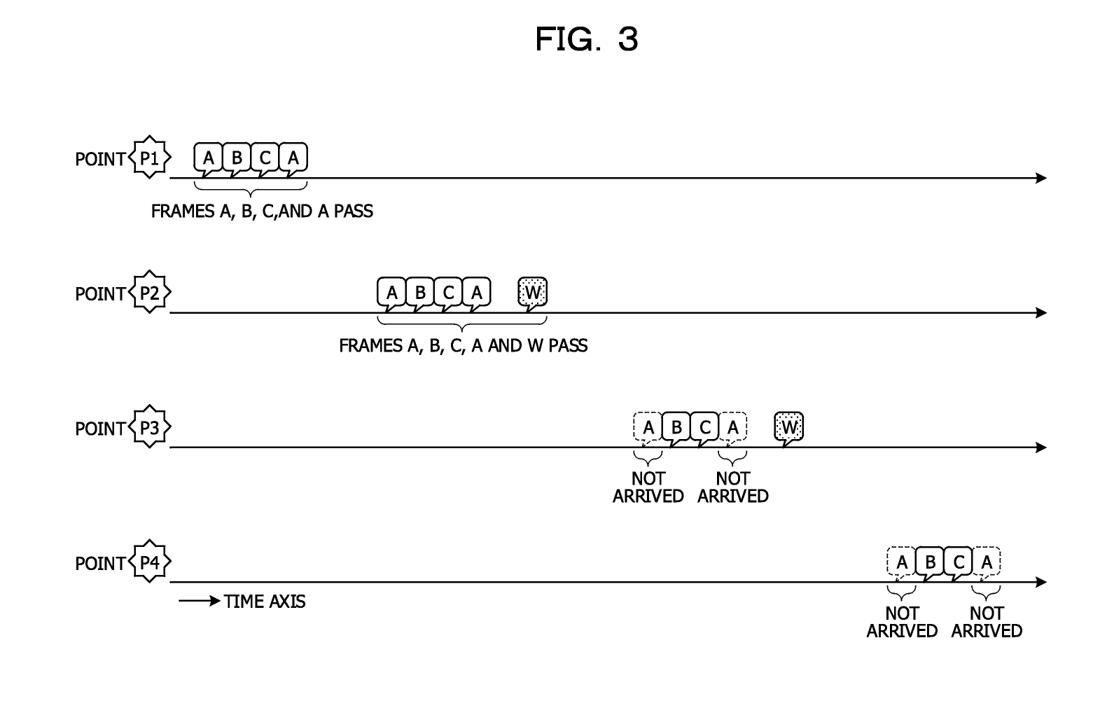

FIG. 2 is an explanatory diagram illustrating one example of a flow of frames in a transmission device. FIG. 3 is an explanatory diagram illustrating one example of a flow of frames and a monitoring frame at each of points in a transmission device. The transmission device illustrated in reference to FIGS. 2 and 3 may be the transmission device 1 illustrated in FIG. 1. The points illustrated in reference to FIG. 3 may be the points P1 to P4 illustrated in FIG. 2. For convenience of explanation, suppose that the output stage of the first queue 141 in the queue control unit 14 involves failure.

At the point P1, frames pass in order of the user A, the user B, the user C, and the user A. At the point P2, frames pass in order of the user A, the user B, the user C, the user A, and monitoring frame W. At the point P3, frames pass in order of the user B, the user C, and the monitoring frame W, because the frames of the user A have not arrived. At the point P4, frames pass in order of the user B and the user C, because the frames of the user A have not arrived.

The first acquiring unit 12A of the first control unit 12 acquires the frame information F1 of the point P1 about the user A, the user B, the user C, and the user A. The first information generating unit 12B in the first control unit 12 generates the stored information S1 of the user A, the user B, and the user C on the basis of the frame information F1. Then, the first information generating unit 12B outputs the generated stored information S1 to the generating unit 13.

The generating unit 13 outputs the monitoring frame W in which the stored information S1 is stored to the point P2 of the communication path 5. The queue control unit 14 stores the frames of the user A, the frame of the user B, the frame of the user C, and the monitoring frame W in the first queue 141, the second queue 142, the third queue 143, and the fourth queue 144, respectively, and sequentially outputs the respective frames to the route switch 15. The output stage of the first queue 141 is in the state in which the output stage does not output the frames of the user A because of failure.

The detecting unit 22 detects the monitoring frame W from the frames that pass through the point P3 of the communication path 5. The second monitoring unit 21 extracts the frame information F2 of the user B and the user C from the frames that pass through the point P4 of the communication path 5. The second acquiring unit 31 in the second control unit 23 acquires the frame information F2. The extracting unit 32 in the second control unit 23 extracts the stored information S1 stored in the monitoring frame W. The comparing unit 33 in the second control unit 23 compares the frame information F2 and the stored information S1 and determines that the path of the frame of the user A is in failure because the user type of the user A is left as the difference result of the comparison.

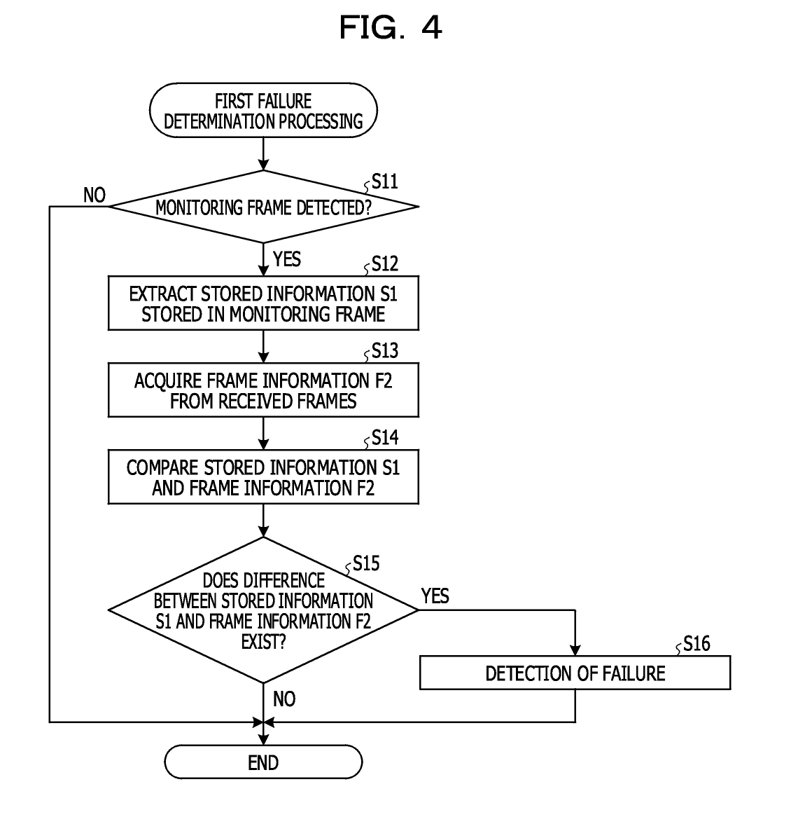

FIG. 4 is a flowchart illustrating one example of processing operation of a second control unit regarding first failure determination processing. The second control unit illustrated in reference to FIG. 4 may be the second control unit 23 illustrated in FIG. 1. The first failure determination processing is processing of comparing the stored information S1, which is the frame information F1 of the point P1 stored in the detected monitoring frame W, and the frame information F2 of the point P4 and determining path failure of the frame of each user on the basis of the comparison result. In FIG. 4, the second control unit 23 determines whether or not the monitoring frame W is detected through the detecting unit 22 (S11). The extracting unit 32 in the second control unit 23 extracts the stored information S1 stored in the monitoring frame W (S12). The stored information S1 is information on the frame information F1 of the frames that have passed through the point P1 by immediately before the output timing of the monitoring frame W, and so forth. The second acquiring unit 31 in the second control unit 23 acquires the frame information F2 from the received frames through the second monitoring unit 21 (S13). The frame information F2 is information including the user types of the frames that have passed through the point P4.

The comparing unit 33 in the second control unit 23 compares the stored information S1 and the frame information F2 (S14). The first determining unit 34 in the second control unit 23 determines whether or not the difference between the stored information S1 and the frame information F2 exists on the basis of the comparison result (S15). If the difference between the stored information S1 and the frame information F2 exists (Yes of S15), the first determining unit 34 determines that the path of the frame of the user type about which the difference exists is in failure (S16), and ends the processing operation illustrated in FIG. 4.

If the difference between the stored information S1 and the frame information F2 does not exist (No of S15), the second control unit 23 determines that the paths are normal, and ends the processing operation illustrated in FIG. 4. If the monitoring frame W is not detected (No of S11), the second control unit 23 ends the processing operation illustrated in FIG. 4.

The first control unit 12 in the transmission device 1 of embodiment 1 acquires the user types of the frames that pass through the point P1 by immediately before the output timing of the monitoring frame W. Then, the first control unit 12 stores the acquired user types as the stored information S1 in the monitoring frame W and outputs the stored information S1. Furthermore, if the monitoring frame W is detected, the second control unit 23 in the transmission device 1 compares the frame information F2 of the frames that actually pass through the point P4 and the stored information S1 in the monitoring frame W. Then, the second control unit 23 determines path failure of each user frame on the basis of the comparison result. That is, path failure of each user frame can be determined on the basis of the result of the comparison between the user types of the frames that have passed through the point P1 and the user types of the frames that have passed through the point P4. The transmission device 1 can also check the continuity of the signal in the transmission device 1 on the basis of whether or not the monitoring signal W is detected.

The transmission device 1 can determine path failure of each user frame without increasing the number of monitoring signals. For this reason, the transmission device 1 can determine path failure of each user frame with high accuracy while suppressing increase in the traffic amount in the device. In addition, the transmission device 1 can determine path failure of each user frame in real time.

In the queue control unit 14 in the above-described embodiment 1, the case in which the input order and output order of the frame are identical is exemplified. Besides, there is also the case in which a preferential output unit by which the output order of the frame is changed according to predetermined preference order is provided in the queue control unit 14. Therefore, to cope with such a situation, besides the user type of the frame that passes through the point P1, the number of times of passing of the frame (the number of frames) may be stored in the stored information S1 stored in the monitoring frame W. An embodiment of this case will be described below as embodiment 2.

### Embodiment 2

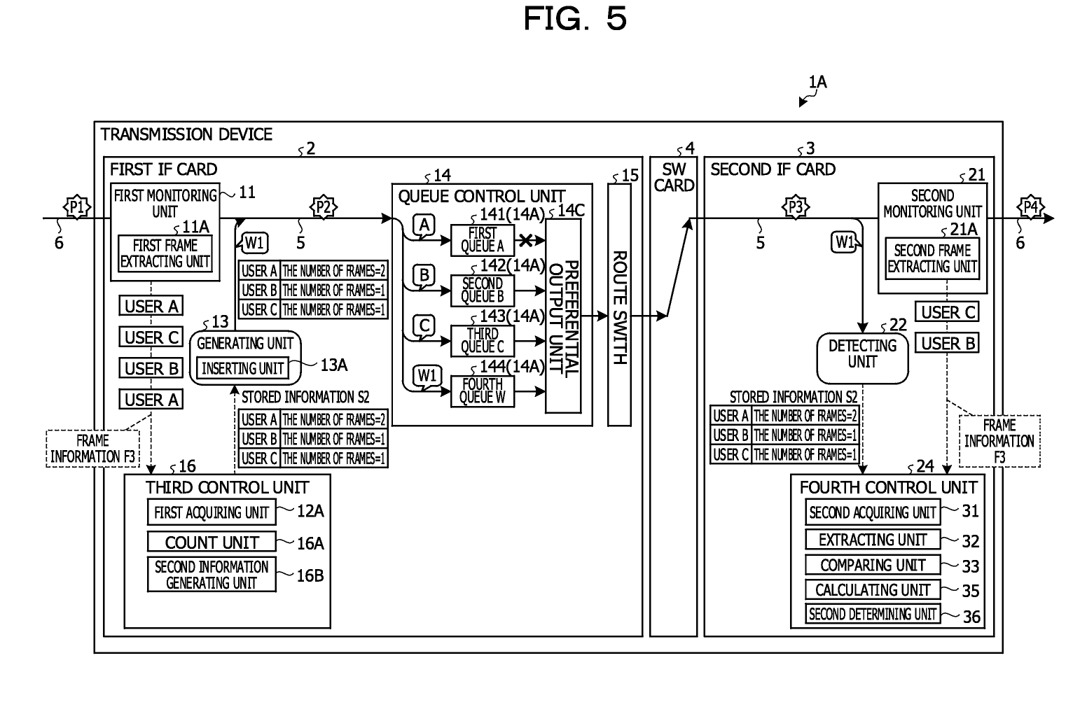

FIG. 5 is an explanatory diagram illustrating one example of a configuration in a transmission device of embodiment 2. The same configuration as the transmission device 1 illustrated in FIG. 1 is given the same symbol and thereby description of the overlapping configuration and operation is omitted.

In a transmission device 1A illustrated in FIG. 5, a third control unit 16 is provided instead of the first control unit 12 in the first IF card 2. The third control unit 16 includes a count unit 16A and a second information generating unit 16B besides the first acquiring unit 12A. The count unit 16A acquires frame information F3 of the point P1 through the first monitoring unit 11. Then, on the basis of the acquired frame information F3, the count unit 16A counts the number of times of passing of the frame, i.e. the number of frames, regarding each of the user types of the frames that pass through the point P1.

The second information generating unit 16B acquires the user types of the frames on the basis of the frame information F3. Then, the second information generating unit 16B generates stored information S2 associated with the user types and the number of frames of each of the user types and outputs the stored information S2 to the generating unit 13. The inserting unit 13A in the generating unit 13 inserts the stored information S2 in a monitoring frame W1 and outputs the monitoring frame W1 in which the stored information S2 is inserted to the point P2. The queue control unit 14 includes a preferential output unit 14C that outputs frames stored in the respective queues 14A to the route switch 15 according to preference order, instead of the multiplexer 14B. For example, suppose that, in the preference order, the highest rank is the frame of the user A, the second rank is the frame of the user B, the third rank is the frame of the user C, and the lowest rank is the monitoring frame W1.

The second IF card 3 has the second monitoring unit 21 and the detecting unit 22. The second IF card 3 further includes a fourth control unit 24 instead of the second control unit 23. The fourth control unit 24 includes the second acquiring unit 31, the extracting unit 32, and the comparing unit 33. The fourth control unit 24 includes a calculating unit 35 and a second determining unit 36 instead of the first determining unit 34.

On the basis of frame information F4 acquired at the point P4 in the second monitoring unit 21, the second acquiring unit 31 acquires the user types of the frame information F4 and the numbers of frames about the frames corresponding to the user types. The extracting unit 32 extracts user types and the number of frames of each of the user types on the basis of the stored information S2 stored in the monitoring frame W1 that passes through the point P3. The comparing unit 33 compares the frame information F4 and the stored information S2 regarding each user type.

The calculating unit 35 subtracts the number of frames of the stored information S2 from the number of frames of the frame information F4 to calculate the subtraction result regarding each user type. The subtraction result of each user type is employed as present difference information. Moreover, the calculating unit 35 adds the present difference information and the previous difference information to calculate the addition result. That is, the calculating unit 35 adds the number of frames in the present difference information and the number of frames in the previous difference information to be described later to calculate the addition result regarding each user type.

The second determining unit 36 determines whether or not the number of frames of each user type in the addition result is equal to or larger than 0. If the number of frames in the addition result is not equal to or larger than 0, the second determining unit 36 determines that the path of the frame corresponding to the user type about which the number of frames is not equal to or larger than 0 is in failure. If the number of frames of each user type in the addition result is equal to or larger than 0, the second determining unit 36 determines that the paths are normal, and holds the difference information as the previous difference information.

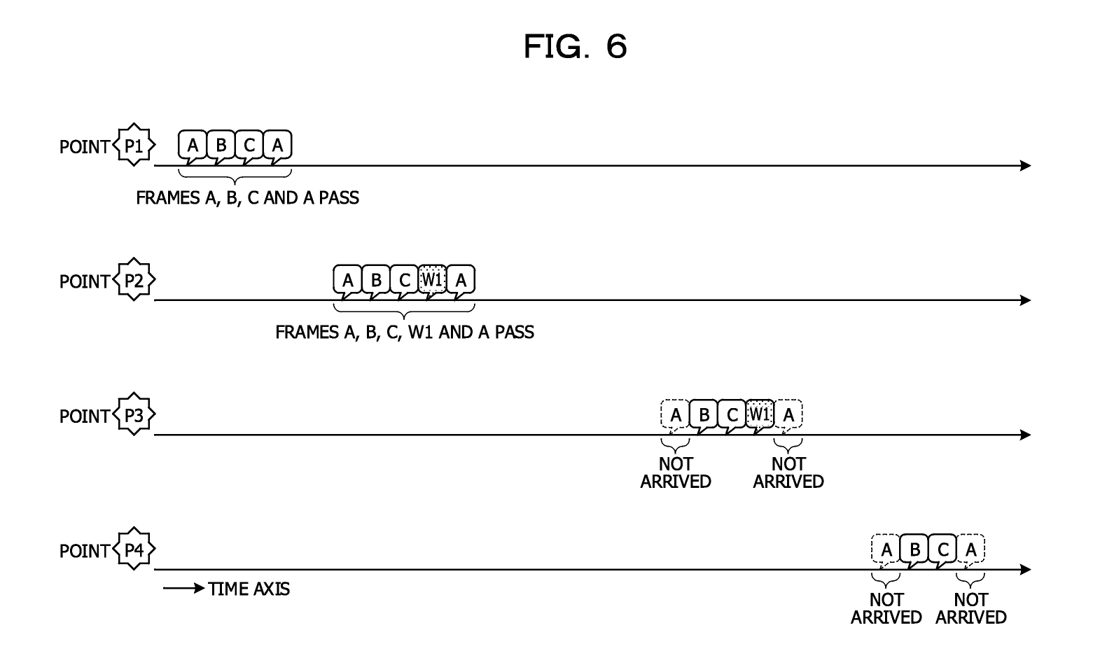

Next, the operation of the transmission device 1A of embodiment 2 will be described. FIG. 6 is an explanatory diagram illustrating one example of a flow of frames and a monitoring frame at each of points in a transmission device. The points and the transmission device illustrated in reference to FIG. 6 may be the points P1 to P4 and the transmission device 1A illustrated in FIG. 5, respectively. At the point P1 illustrated in FIG. 6, frames pass in order of the user A, the user B, the user C, and the user A. The first acquiring unit 12A acquires the frame information F3 of the point P1 about the user A, the user B, the user C, and the user A. The second information generating unit 16B generates the stored information S2 on the basis of the frame information F3 and outputs the generated stored information S2 to the generating unit 13. The stored information S2 is information such as the number “2” of frames of the user A, the number “1” of frames of the user B, and the number “1” of frames of the user C. The generating unit 13 stores the stored information S2 in the monitoring frame W1 and outputs the monitoring frame W1 in which the stored information S2 is stored to the point P2. At the point P2, frames pass in order of the user A, the user B, the user C, the monitoring frame W1, and the user A.

At the point P3, frames pass in order of the user B, the user C, and the monitoring frame W1, because the output stage of the first queue 141 is in failure and the frames of the user A have not arrived for example. The detecting unit 22 detects the monitoring frame W1 from the frames that pass through the point P3. Then, the detecting unit 22 extracts the stored information S2 from the monitoring frame W1. The stored information S2 is information such as the number “2” of frames of the user A, the number “1” of frames of the user B, and the number “1” of frames of the user C.

At the point P4, frames pass in order of the user B and the user C, because the frames of the user A have not arrived. The second monitoring unit 21 extracts the frame information F4 of the point P4 as the number “0” of frames of the user A, the number “1” of frames of the user B, and the number “1” of frames of the user C.

The calculating unit 35 subtracts the stored information S2 from the frame information F4 to obtain the present difference information regarding each user type. The present difference information is the number of frames of each user type as the number “−2” of frames of the user A, the number “0” of frames of the user B, and the number “0” of frames of the user C for example. The calculating unit 35 obtains the addition result obtained by adding the present difference information and the previous difference information regarding each user type. For example, the previous difference information is the previous number of frames of each user type as the number “0” of frames of each of the user A, the user B, and the user C.

The addition result of the present difference information and the previous difference information is the number “−2” of frames of the user A, the number “0” of frames of the user B, and the number “0” of frames of the user C and the second determining unit 36 determines that the path of the frame of the user A is in failure because the number of frames of the user A is “−2.” The fourth control unit 24 may reset the present difference information at the timing when it is determined that the path of the user frame is in failure.

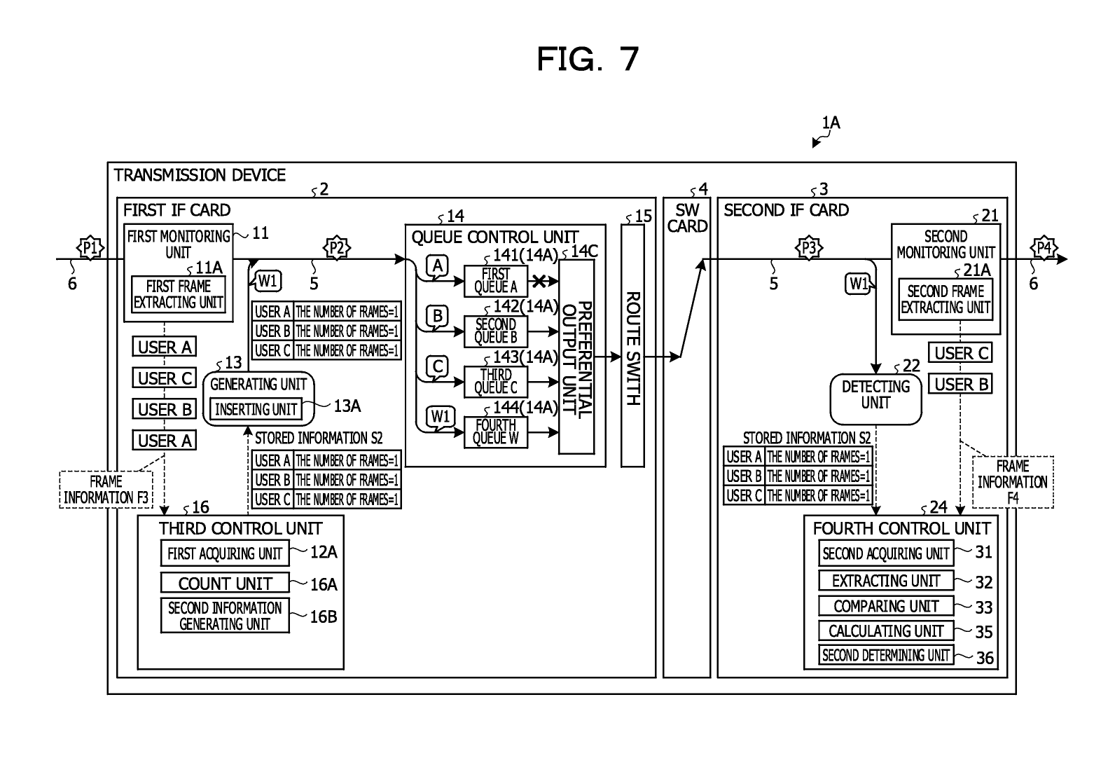

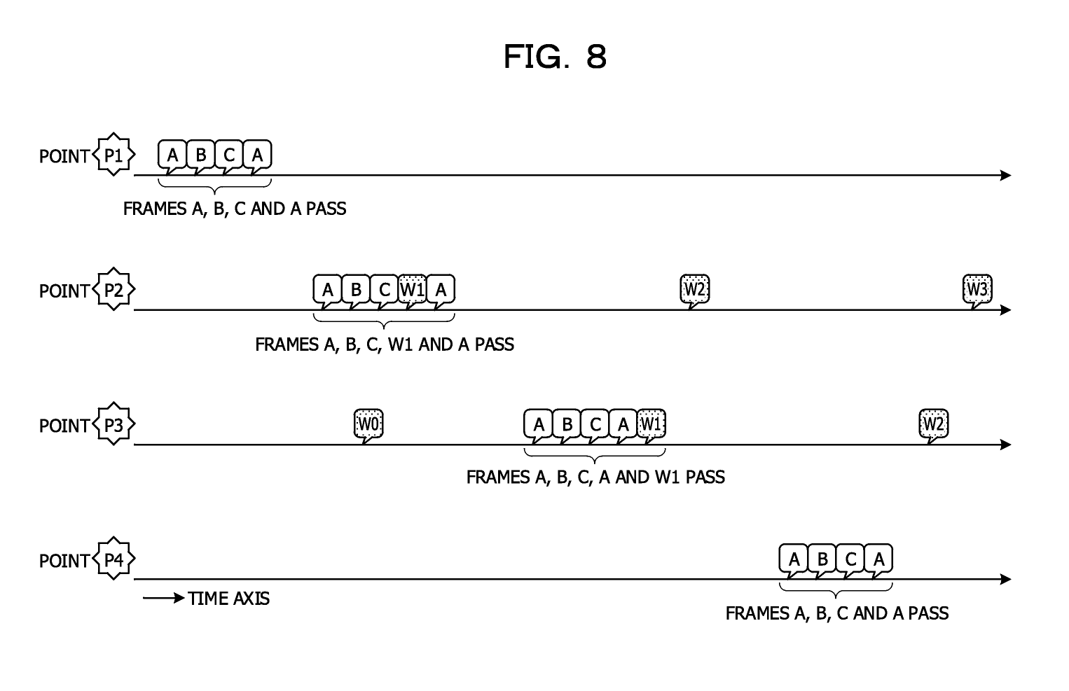

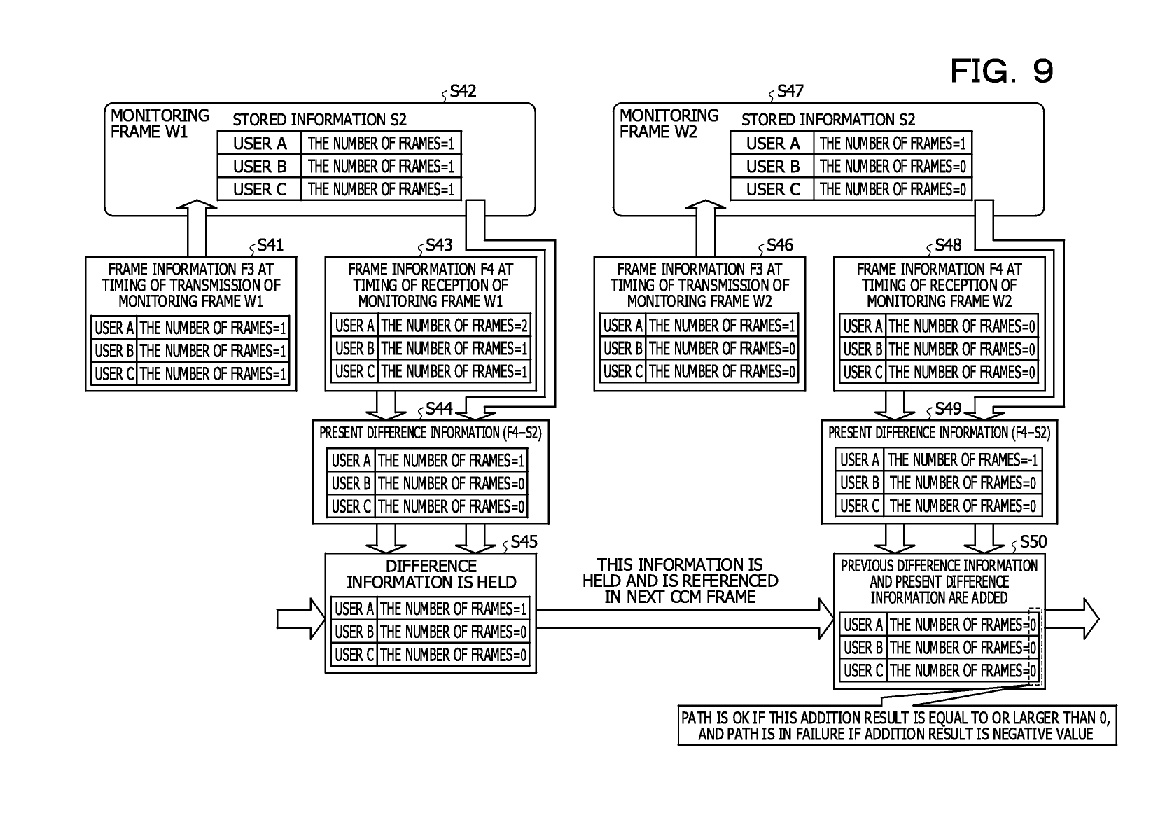

FIG. 7 is an explanatory diagram illustrating one example of a flow of frames and a monitoring frame in a transmission device. FIG. 8 is an explanatory diagram illustrating one example of a flow of frames and monitoring frames at each of points in a transmission device when paths are normal. FIG. 9 is an explanatory diagram illustrating one example of frame information, stored information, and difference information (when paths are normal). The transmission device illustrated in reference to FIGS. 7 and 8, the points illustrated in reference to FIG. 8, and the frame information and the stored information illustrated in reference to FIG. 9 may be the transmission 1A, the points P1 to P4, the frame information F3, and the stored information S2 illustrated in FIG. 5, respectively. At the point P1 illustrated in FIG. 8, frames pass in order of the user A, the user B, and the user C. As illustrated in FIG. 9, the first acquiring unit 12A acquires the frame information F3 of the user A, the user B, and the user C at the point P1 (S41). For example, the number of frames of the user A, the user B, and the user C is “1.” The second information generating unit 16B generates the stored information S2 on the basis of the frame information F3 and outputs the generated stored information S2 to the generating unit 13 (S42). The stored information S2 is the number “1” of frames of the user A, the number “1” of frames of the user B, and the number “1” of frames of the user C by immediately before the output timing of the monitoring frame W1. The generating unit 13 stores the stored information S2 in the monitoring frame W1 and outputs the monitoring frame W1 to the point P2. At the point P2, frames pass in order of the user A, the user B, the user C, the monitoring frame W1, and the user A.

At the point P3, frames pass in order of the user A, the user B, the user C, the user A, and the monitoring frame W1. The detecting unit 22 detects the monitoring frame W1 at the point P3 and extracts the stored information S2 from the monitoring frame W1.

At the point P4, frames pass in order of the user A, the user B, the user C, and the user A. The second monitoring unit 21 extracts the frame information F4 of the point P4 as the number “2” of frames of the user A, the number “1” of frames of the user B, and the number “1” of frames of the user C (S43).

The calculating unit 35 subtracts the stored information S2 from the frame information F4 to obtain the present difference information (S44). For example, in the case of the user A, the calculating unit 35 subtracts the number “1” of frames from the number “2” of frames to obtain the number “1” of frames. In the case of the user B, the calculating unit 35 subtracts the number “1” of frames from the number “1” of frames to obtain the number “0” of frames. In the case of the user C, the calculating unit 35 subtracts the number “1” of frames from the number “1” of frames to obtain the number “0” of frames. That is, the present difference information is the number of frames of each user type, specifically e.g. the number “1” of frames of the user A, the number “0” of frames of the user B, and the number “0” of frames of the user C. The calculating unit 35 adds the present difference information and the previous difference information regarding each user type to obtain the addition result of each user type. Suppose that the previous difference information is the number “0” of frames of each of the user A, the user B, and the user C.

Regarding each user type, the addition result of the present difference information and the previous difference information is the number “1” of frames of the user A, the number “0” of frames of the user B, and the number “0” of frames of the user C. Then, the second determining unit 36 determines that the path of each user frame is normal because each of the numbers of frames is equal to or larger than 0 (S45).

Moreover, at the point P1 illustrated in FIG. 8, a frame of the user A passes at timing in the period from the output of the previous monitoring frame W1 to output of the next monitoring frame W2. The first acquiring unit 12A acquires the frame information F3 of the point P1 about the user A (S46). For example, the number of frames of the user A is “1” and the numbers of frames of the user B and the user C are “0.” The second information generating unit 16B generates the stored information S2 on the basis of the frame information F3 and outputs the generated stored information S2 to the generating unit 13 (S47). The stored information S2 is information of the number “1” of frames of the user A, the number “0” of frames of the user B, and the number “0” of frames of the user C. The generating unit 13 stores the stored information S2 in the monitoring frame W2 and outputs the monitoring frame W2 to the point P2. At the point P2, the monitoring frame W2 passes.

At the point P3, the monitoring frame W2 passes. The detecting unit 22 detects the monitoring frame W2 at the point P3 and extracts the stored information S2 from the monitoring frame W2. At the point P4, the monitoring frame W2 passes. The second monitoring unit 21 extracts the frame information F4 at the point P4 as the number “0” of frames of the user A, the number “0” of frames of the user B, and the number “0” of frames of the user C (S48).

The calculating unit 35 subtracts the stored information S2 from the frame information F4 to obtain the present difference information regarding each user type (S49). For example, in the case of the user A, the calculating unit 35 subtracts the number “1” of frames from the number “0” of frames to obtain the number “−1” of frames. In the case of the user B, the calculating unit 35 subtracts the number “0” of frames from the number “0” of frames to obtain the number “0” of frames. In the case of the user C, the calculating unit 35 subtracts the number “0” of frames from the number “0” of frames to obtain the number “0” of frames. That is, the present difference information is the number “−1” of frames of the user A, the number “0” of frames of the user B, and the number “0” of frames of the user C. The calculating unit 35 adds the present difference information and the previous difference information regarding each user type. Suppose that the previous difference information is the number “1” of frames of the user A, the number “0” of frames of the user B, and the number “0” of frames of the user C.

Regarding each user type, the addition result of the present difference information and the previous difference information is the number “0” of frames of the user A, the number “0” of frames of the user B, and the number “0” of frames of the user C. Then, the second determining unit 36 determines that the path of each user frame is normal because each of the numbers of frames is equal to or larger than 0 (S50).

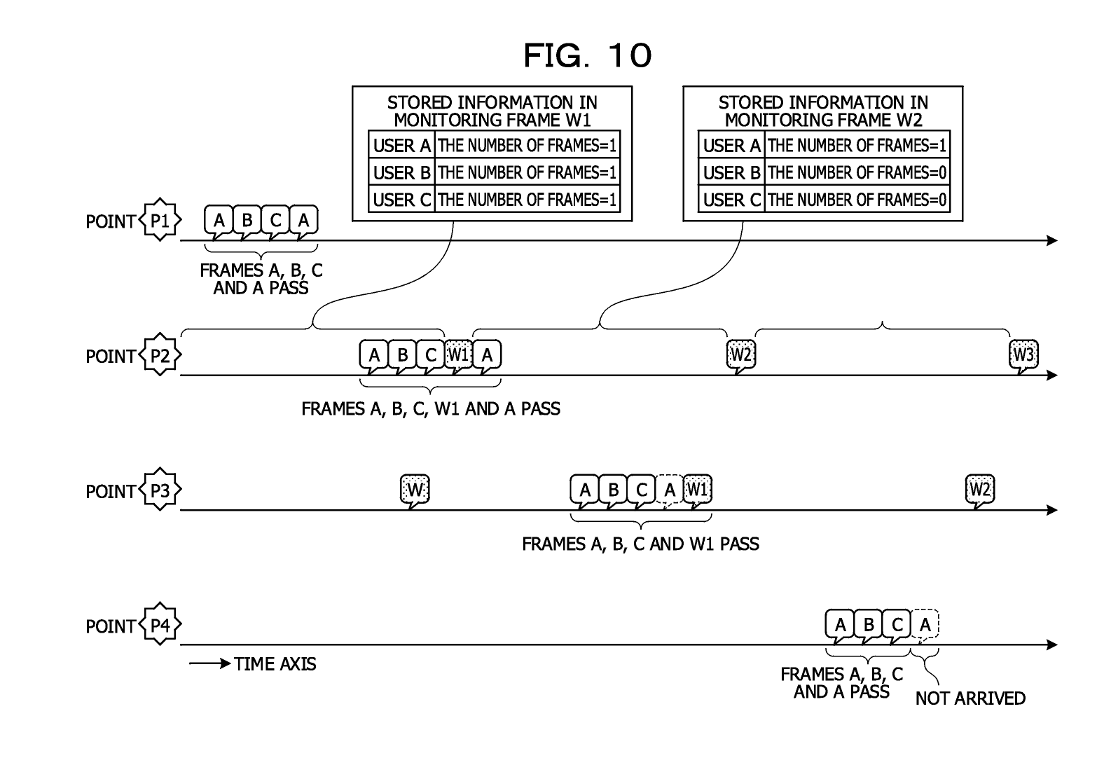

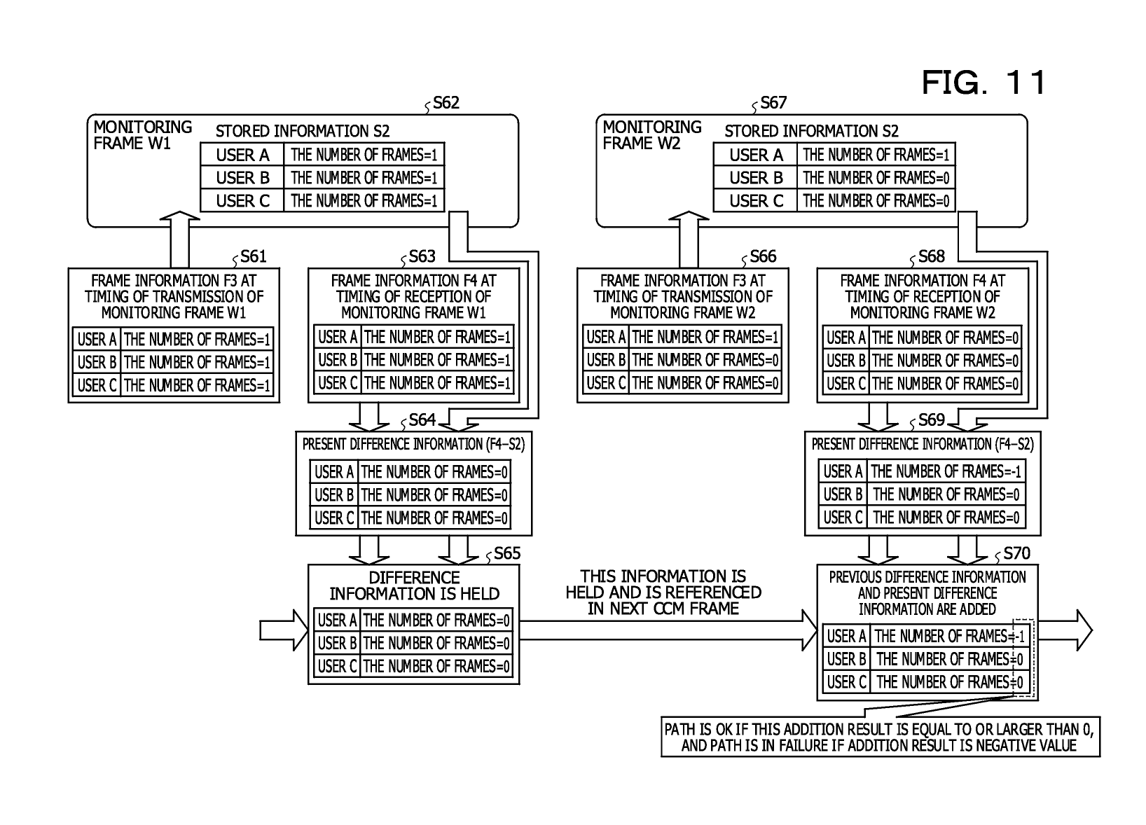

FIG. 10 is an explanatory diagram illustrating one example of a flow of frames and monitoring frames at each of points in a transmission device (when a path is in failure). FIG. 11 is an explanatory direction illustrating one example of frame information, stored information, and difference information (when a path is in failure). The transmission device illustrated in reference to FIG. 10, the points illustrated in reference to FIG. 10, and the frame information and the stored information illustrated in reference to FIG. 11 may be the transmission 1A, the points P1 to P4, the frame information F3, and the stored information S2 illustrated in FIG. 5, respectively. At the point P1 illustrated in FIG. 10, frames of the user A, the user B, the user C, and the user A pass. The first acquiring unit 12A acquires the frame information F3 of the point P1 as the numbers of frames of the user A, the user B, and the user C by immediately before the output timing of the monitoring frame W1 (S61). For example, the numbers of frames of the user A, the user B, and the user C are “1.” The second information generating unit 16B generates the stored information S2 of the number “1” of frames of the user A, the number “1” of frames of the user B, and the number “1” of frames of the user C and outputs the generated stored information S2 to the generating unit 13 (S62). The generating unit 13 outputs the monitoring frame W1 in which the stored information S2 is stored to the point P2. Moreover, at the point P2, frames of the user A, the user B, the user C, the monitoring frame W1, and the user A pass.

Furthermore, suppose that, at the point P3, although the frames of the user A, the user B, the user C, and the monitoring frame W1 pass, the frame of the user A to come next has not arrived. Suppose that, at the point P4, although the user A, the user B, and the user C pass, the next user A has not arrived. The second acquiring unit 31 acquires the frame information F4 of the point P4 as the number “1” of frames of the user A, the number “1” of frames of the user B, and the number “1” of frames of the user C (S63). The calculating unit 35 subtracts the stored information S2 in the monitoring frame W1 from the frame information F4 to obtain the present difference information regarding each user type (S64). For example, in the case of the user A, the calculating unit 35 subtracts the number “1” of frames from the number “1” of frames to obtain the number “0” of frames. In the case of the user B, the calculating unit 35 subtracts the number “1” of frames from the number “1” of frames to obtain the number “0” of frames. In the case of the user C, the calculating unit 35 subtracts the number “1” of frames from the number “1” of frames to obtain the number “0” of frames. That is, the present difference information is the number “0” of frames of the user A, the number “0” of frames of the user B, and the number “0” of frames of the user C. The calculating unit 35 adds the present difference information and the previous difference information regarding each user type. The addition result of the present difference information and the previous difference information is the number “0” of frames of the user A, the number “0” of frames of the user B, and the number “0” of frames of the user C, and the second determining unit 36 determines that the paths of the user frames are normal because each of the numbers of frames is equal to or larger than 0 (S65).

Furthermore, the first acquiring unit 12A acquires the frame information F3 of the point P1 as the number “1” of frames of the user A by immediately before the output timing of the next monitoring frame W2 (S66). For example, the number of frames of the user A is “1” and the numbers of frames of the user B and the user C are “0.” The second information generating unit 16B generates the stored information S2 on the basis of the frame information F3 and outputs the stored information S2 to the generating unit 13. The generating unit 13 stores the stored information S2 in the monitoring frame W2 and outputs the monitoring frame W2 in which the stored information S2 is stored to the point P2 (S67).

The extracting unit 32 detects the monitoring frame W2 at the point P3 and extracts the stored information S2 from the monitoring frame W2. The stored information S2 is information of the number “1” of frames of the user A, the number “0” of frames of the user B, and the number “0” of frames of the user C. Furthermore, the second acquiring unit 31 acquires the frame information F4 of the point P4 as the number “0” of frames of the user A, the number “0” of frames of the user B, and the number “0” of frames of the user C from the second monitoring unit 21 (S68). The calculating unit 35 subtracts the stored information S2 from the frame information F4 to obtain the present difference information regarding each user type (S69). For example, in the case of the user A, the calculating unit 35 subtracts the number “1” of frames from the number “0” of frames to obtain the number “−1” of frames. In the case of the user B, the calculating unit 35 subtracts the number “0” of frames from the number “0” of frames to obtain the number “0” of frames. In the case of the user C, the calculating unit 35 subtracts the number “0” of frames from the number “0” of frames to obtain the number “0” of frames. That is, the present difference information is the number “−1” of frames of the user A, the number “0” of frames of the user B, and the number “0” of frames of the user C.

The calculating unit 35 adds the present difference information and the previous difference information to obtain the addition result regarding each user type. Then, because the number of frames in the addition result is not equal to or larger than 0, i.e. the number of frames of the user A is “−1,” the second determining unit 36 determines that the path of the frame of the user A is in failure (S70).

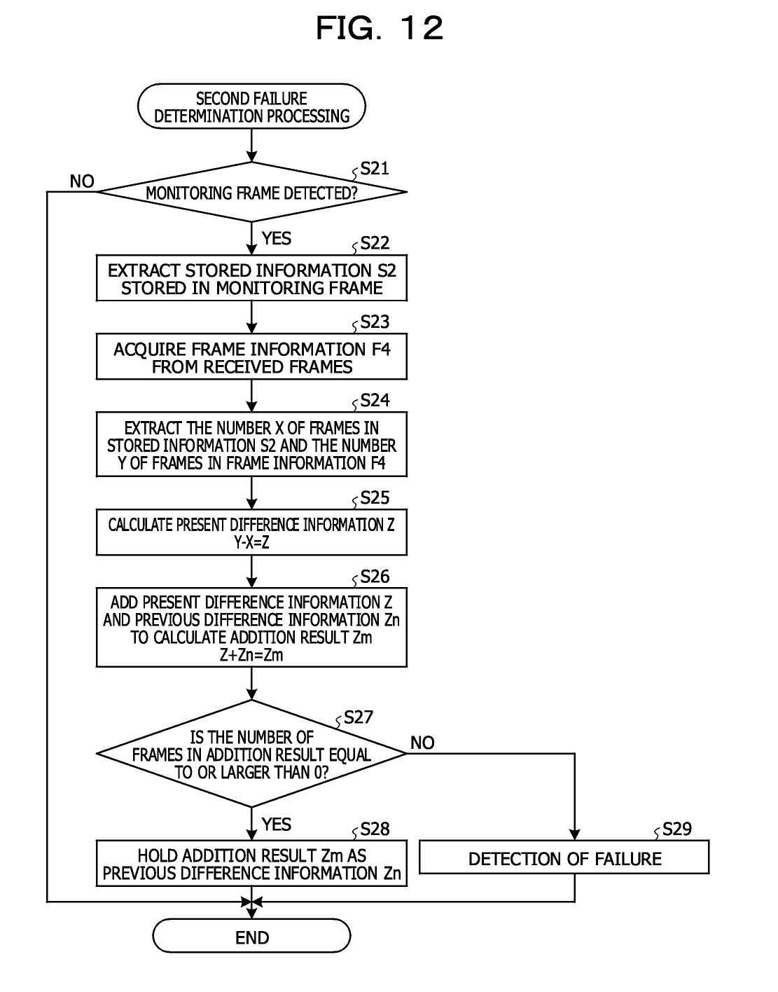

FIG. 12 is a flowchart illustrating one example of processing operation of a fourth control unit regarding second failure determination processing. The fourth control unit illustrated in reference to FIG. 12 may be the fourth control unit 24 illustrated in FIG. 5. The second failure determination processing is processing of comparing the number of frames of each user type passing through the point P1, stored in the detected monitoring frame W, and the number of frames of each user type passing through the point P4 and determining path failure of each user frame on the basis of the comparison result.

The fourth control unit 24 determines whether or not the monitoring frame W is detected through the detecting unit 22 (S21). If the monitoring frame W is detected (Yes of S21), the extracting unit 32 in the fourth control unit 24 extracts the stored information S2 stored in the monitoring frame W (S22). The second acquiring unit 31 in the fourth control unit 24 acquires the frame information F4 from the received frames through the second monitoring unit 21 (S23).

The comparing unit 33 in the fourth control unit 24 compares the numbers of frames between the stored information S2 and the frame information F4 regarding each user type (S24). The calculating unit 35 in the fourth control unit 24 subtracts the number X of frames of the stored information S2 from the number Y of frames of the frame information F4 and obtains the present difference information Z as the subtraction result regarding each user type (S25).

The calculating unit 35 adds the present difference information and the previous difference information regarding each user type to obtain the addition result (S26). The second determining unit 36 in the fourth control unit 24 determines whether or not the number of frames of each user type in the addition result is equal to or larger than 0 (S27).

If the number of frames in the addition result is not equal to or larger than 0 (No of S27), the second determining unit 36 determines that the path of the frame is in failure (S29), and ends the processing operation illustrated in FIG. 12. If the number of frames in the addition result is equal to or larger than 0 (Yes of S27), the fourth control unit 24 determines that the path of the user frame is normal, and holds the addition result as the previous difference information (S28). Then, the fourth control unit 24 ends the processing operation illustrated in FIG. 12.

If the monitoring frame W is not detected (No of S21), the fourth control unit 24 ends the processing operation illustrated in FIG. 12.

The third control unit 16 in the transmission device 1A acquires the number of frames of each user type regarding the frame that passes through the point P1 by immediately before the output timing of the monitoring frame W1. Then, the third control unit 16 stores the acquired number of frames of each user type as the stored information S2 in the monitoring frame W1 and outputs the stored information S2. Furthermore, if the monitoring frame W1 is detected, the fourth control unit 24 in the transmission device 1A compares the number of frames of each user type regarding the frame that passes through the point P4 and the number of frames of each user type in the stored information S2 in the monitoring frame W1. On the basis of the comparison result, the fourth control unit 24 determines path failure of each user frame. That is, path failure of each user frame can be determined on the basis of the result of the comparison between the number of frames of each user type regarding the frame that passes through the point P1 and the number of frames of each user type regarding the frame that passes through the point P4.

In the transmission device 1A of embodiment 2, even when the output order of the frame is changed in the preferential output unit 14C in the queue control unit 14, the number of frames of each user type regarding the frame that passes through the point P1 and the number of frames of each user type regarding the frame that passes through the point P4 are compared. As a result, path failure of each user frame can be determined even when the output order is changed.

In the transmission device 1A, even when the output order is changed, erroneous determination of path failure due to the change in the output order is not made and path failure of each user frame can be determined.

In the above-described embodiments, path failure of each user frame on the communication path 5 in the transmission device 1 (1A) is determined. However, path failure of each user frame on the transmission line 6 between transmission devices can also be determined. In this case, the transmission device includes the first monitoring unit 11, the first control unit 12, and the generating unit 13. Furthermore, the transmission device on the counterpart side coupled to the transmission device by the transmission line 6 includes the second monitoring unit 21, the detecting unit 22, and the second control unit 23.

In the above-described embodiments, the user type of the frame is exemplified as the identification information. However, the identification information is not limited to the user type. The class type of the frame may be used and the identification information can be changed as appropriate.

In the above-described embodiments, path failure of each user frame in the transmission device is determined. However, the determination subject is not limited to the frame and may be various kinds of signals such as the packet for example.

The respective constituent elements of the respective units illustrated in the diagrams do not necessarily need to be configured as illustrated in the diagrams physically. Specifically, concrete forms of distribution and integration of the respective units are not limited to those illustrated in the diagrams, and all or part thereof can be configured to be distributed and integrated functionally or physically in arbitrary unit according to various kinds of load, the status of use, and so forth.

Furthermore, all or an arbitrary part of various kinds of processing functions carried out in the respective devices may be executed on a central processing unit (CPU), a digital signal processor (DSP), a field programmable gate array (FPGA), or the like. All or an arbitrary part of the various kinds of processing functions may be executed on a program analyzed and executed by a CPU or the like or on hardware based on wired logic.

The region to store various kinds of information may be configured by a read only memory (ROM) or a random access memory (RAM) such as a synchronous dynamic random access memory (SDRAM), a magnetoresistive random access memory (MRAM), or a non-volatile random access memory (NVRAM) for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A failure determination method executed by a transmission device, the failure determination method comprising:
acquiring first identification information to identity types of a plurality of signals that have passed through an input terminal of the transmission device;
generating a monitoring signal in which the first identification information is stored;
inserting the generated monitoring signal into the input terminal;
acquiring second identification information to identify the types of the plurality of signals when the plurality of signals transmitted through the input terminal pass through an output terminal of the transmission device;
extracting the first identification information from the monitoring signal that is transmitted from the input terminal and is detected at the output terminal; and
determining path failure between the input terminal and the output terminal regarding each of a plurality of types by comparing the second identification information and the first identification information extracted from the monitoring signal.

2. The failure determination method according to claim 1,
wherein each of the plurality of signals passes through a path that is different for each type of the signal and is transmitted from the input terminal to the output terminal.

3. The failure determination method according to claim 1,
wherein the monitoring signal is transmitted from the input terminal to the output terminal by using a path different from a plurality of paths used by the plurality of signals.

4. The failure determination method according to claim 1,
wherein the acquiring the first identification information includes acquiring identification information of the plurality of signals that have passed through the input terminal in a period from insertion timing of a previous monitoring signal to immediately before insertion timing of a present monitoring signal in insertion of the monitoring signal into the input terminal at every predetermined timing, and
wherein the acquiring the second identification information includes acquiring identification information of the plurality of signals that have passed through the output terminal in a period from detection of the previous monitoring signal to detection of the present monitoring signal at the output terminal.

5. The failure determination method according to claim 1, wherein
the first identification information is information in which the type and the number of signals that have passed through the input terminal are associated regarding each of the plurality of types, and
the second identification information is information in which the type and the number of signals that have passed through the output terminal are associated regarding each of the plurality of types.

6. The failure determination method according to claim 1,
wherein the type is information on a user that transmits the signal.

7. The failure determination method according to claim 1,
wherein the type is information on a class of the signal.

8. The failure determination method according to claim 1,
wherein the determining includes determining whether or not difference between the second identification information and the first identification information extracted from the monitoring signal exists regarding each of the plurality of types.

9. The failure determination method according to claim 1, wherein
the input terminal is included in a first device, and
the output terminal is included in a second device coupled to the first device via a transmission line, and
the determining include determining path failure on the transmission line.

10. A transmission device, comprising:
a first interface card configured to include an input terminal; and
a second interface card coupled to the first interface card and include an output terminal,
wherein the first interface card is configured to:
acquire first identification information to identity types of a plurality of signals that have passed through the input terminal; and
generate a monitoring signal in which the first identification information is stored and insert the generated monitoring signal into the input terminal, and
wherein the second interface card is configured to:
acquire second identification information to identify the types of the plurality of signals when the plurality of signals transmitted through the input terminal pass through the output terminal;
extract the first identification information from the monitoring signal that is transmitted from the input terminal and is detected by the output terminal; and
determine path failure between the input terminal and the output terminal regarding each of a plurality of types of signals by comparing the second identification information and the first identification information extracted from the monitoring signal.

11. The transmission device according to claim 10,
wherein each of the plurality of signals passes through a path that is different for each type of the signal and is transmitted from the input terminal to the output terminal.

12. The transmission device according to claim 10,
wherein the monitoring signal is transmitted from the input terminal to the output terminal by using a path different from a plurality of paths used by the plurality of signals.

13. The transmission device according to claim 10,
wherein the first interface card is configured to acquire the first identification information of the plurality of signals that have passed through the input terminal in a period from insertion timing of a previous monitoring signal to immediately before insertion timing of a present monitoring signal in insertion of the monitoring signal into the input terminal at every predetermined timing, and
wherein the second interface card is configured to acquire the second identification information of the plurality of signals that have passed through the output terminal in a period from detection of the previous monitoring signal to detection of the present monitoring signal at the output terminal.

14. The transmission device according to claim 10, wherein
the first identification information is information in which the type and the number of signals that have passed through the input terminal are associated regarding each of the plurality of types, and
the second identification information is information in which the type and the number of signals that have passed through the output terminal are associated regarding each of the plurality of types.

15. The transmission device according to claim 10,
wherein the type is information on a user that transmits the signal.

16. The transmission device according to claim 10,
wherein the type is information on a class of the signal.

17. The transmission device according to claim 10,
wherein the second interface card is configured to determine whether difference between the second identification information and the first identification information extracted from the monitoring signal exists regarding each of the plurality of types.

18. The transmission device according to claim 10,
wherein the second interface card is coupled to the first interface card via a transmission line, and configured to determine path failure on the transmission line.
